(19) United States
(12) Patent Application Publication
(10) Pub. No.: US 2008/0141997 A1
(43) Pub. Date: Jun. 19, 2008

(54) Outdoor gas barbecue grill with an electric self-cleaning unit

(76) Inventor: Chaim Druin, North Miami Beach, FL (US)

Correspondence Address: Ezra Sutton PA, Plaza 9 building, 900 Route 9 North, Woodbridge, NJ, 07095, US

(21) Appl. No.: 11/640,766

(22) Filed: Dec. 18, 2006

(51) Int. Cl. F24C 3/00; A47J 37/07; H05B 1/02

(52) U.S. Cl. 126/39 BA; 126/25 R; 219/492; 219/494

(57) ABSTRACT

An outdoor gas barbecue grill having an electric self-cleaning unit. The gas barbecue grill includes a grill housing, a grill cover, and a lower grill housing for receiving a gas burner and a cooking grate member. The underside of the cooking grate member includes a plurality of heating members made of metal attached thereto. One of the walls of the lower grill housing includes an electric self-cleaning heating unit mounted thereon and includes an electrical conductor member having a plurality of heating elements for detachably connecting to the plurality of heating members on the cooking grate. During a self-cleaning cycle, the heating members are heated to at least 500° F. in order to burn-off and clean the encrusted and burnt food residues on the cooking grate member for sanitizing the cooking grate member. The grill housing further includes a grill lock connected to the grill cover and to the lower grill housing for locking the grill cover relative to the lower grill housing in order to maintain and control the heat production (ΔH) within the closed gas grill for cleaning the cooking grate member during a self-cleaning cycle. Further, one of the walls of the lower grill housing includes an exhaust fan being attached thereto for venting and dissipating the vaporized fumes to the outside air from the burning of the encrusted food residues on the cooking grate member during the self-cleaning cycle.

### FIELD OF THE INVENTION

The present invention relates to a portable outdoor gas barbecue grill having an electric self-cleaning unit. More particularly, the electric self-cleaning unit is attached to the underside of the cooking grill/grate member and during a self-cleaning cycle burns off the encrusted and burnt food residues at a temperature of over 500° F.

### BACKGROUND OF THE INVENTION

Outdoor cooking with portable gas barbecue grills has been growing in popularity as the public interest in outdoor grill cooking has been popularized because of cooking books, the FOOD CHANNEL on cable TV, cooking shows on TV, and by other factors. However, cleaning of these outdoor grills is a tedious job, as a good deal of physical effort is required to clean off the encrusted and burnt food residues from the grill surface by using a wire brush and/or an oven cleanser.

There are a number of problems with building barbecue grills with self-cleaning units which include the following: maintaining a sufficiently high temperature within the gas grill; maintaining a sufficiently uniform distribution of heat to provide a satisfactory cleaning cycle; and providing sufficient heat insulation.

The gas grill is very often not sealed well enough to retain sufficient heat to sustain a self-cleaning cycle. Most important of all is the control of the level of heat production, coupled with the control of a substantially uniform pattern of heat distribution throughout the gas grill.

Accordingly, there remains a need for a built-in electric self-cleaning unit for a portable outdoor gas barbecue grill in order to burn-off the encrusted and burnt food residues at a temperature of over 500° F. Additionally, the portable gas barbecue grill must include a heating unit capable of heating the cooking grate member at temperatures between 500° F. to 900° F., an exhaust fan for dissipating the fumes to the outside air, and a lock for locking the grill cover to the lower grill housing in order to maintain and control the heat production within the closed gas grill for cleaning the cooking grate member. Further, the portable gas barbecue grill should include insulation layers in the walls of the grill cover and lower grill housing to maintain the heat level within the closed gas grill.

### DESCRIPTION OF THE PRIOR ART

Charcoal and gas barbecue grills having various designs, configurations, structures and materials of construction have been disclosed in the prior art. For example, U.S. Pat. No. 3,800,777 to GEIBIEN discloses a portable charcoal cooking unit having a formed wire grill which applies electric power to the grill terminals. This prior art patent does not disclose or teach the design, configuration and structure of the outdoor gas barbecue grill having an electric self-cleaning unit of the present invention.

U.S. Pat. No. 4,508,097 to BERG discloses a self-cleaning indoor barbecue griller that substantially vaporizes cooking residues from a collection receptacle in the form of an absorbent tray. A heating unit is used for the self-cleaning aspect of the griller such that a pair of gas burners or electric heating elements are used for the vaporization process. This prior art patent does not disclose or teach the design, configuration and structure of the outdoor gas barbecue grill having an electric self-cleaning unit of the present invention.

The aforementioned prior art patents do not disclose or teach an outdoor gas barbecue grill having an electric self-cleaning unit which is effective to bum-off the encrusted and burnt food residues at a cleaning cycle temperature of over 500° F.

Accordingly, it is an object of the present invention to provide an outdoor gas barbecue grill having an electric self-cleaning unit connected to the underside of a cooking grill or grate member to produce a temperature of over 500° F. during a self-cleaning cycle to burn-off and/or vaporize the encrusted and burnt food residues from the cooking grate member.

Another object of the present invention is to provide a portable gas barbecue grill that includes a detachable electric self-cleaning heating unit for heating the cooking grate member at temperatures between 500° F. to 900° F. in order to burn off the encrusted and burnt food residues from the food-adhering cooking grate member.

Another object of the present invention is to provide a portable gas barbecue grill having an exhaust fan attached to one of the side walls of the lower grill housing for venting and dissipating the vaporized fumes to the outside air from the burning off and/or vaporization of the burnt food residues and food encrusted matter left on the cooking grate member after cooking.

Another object of the present invention is to provide a portable gas barbecue grill having a grill lock for closing the grill cover relative to the lower grill housing in order to maintain and control the heat production within the closed gas barbecue grill for cleaning the cooking grate member during the self-cleaning cycle.

Another object of the present invention is to provide a portable gas barbecue grill that includes insulation layers in the walls of the grill cover and the lower grill housing in order to maintain the heat produced within the closed gas grill.

Another object of the present invention is to provide an electric self-cleaning unit that is easy to assembly and to mount, and to maintain when in operational use by the operator.

Another object of the present invention is to provide an electric self-cleaning unit having no moving parts that is easy to use and is durable for repeated use by the operator.

A further object of the present invention is to provide a portable gas barbecue grill having an electric self-cleaning unit that can be mass-produced in an automated and economical manner and is readily affordable by the consumer.

### SUMMARY OF THE INVENTION

In accordance with the present invention, there is provided an outdoor gas barbecue grill having an electric self-cleaning unit. The gas barbecue grill includes a grill housing, a grill cover, and a lower grill housing for receiving a gas burner and a cooking grate member. The underside of the cooking grate member includes a plurality of heating members made of metal attached thereto. One of the walls of the lower grill housing includes an electric self-cleaning heating unit mounted thereon and includes an electrical conductor member having a plurality of heating elements for detachably connecting to the plurality of heating members on the cooking grate. During a self-cleaning cycle, the heating members are heated to at least 500° F. in order to burn-off and clean the encrusted and burnt food residues on the cooking grate member for sanitizing the cooking grate member. The grill housing further includes a grill lock connected to the grill cover and to the lower grill housing for locking the grill cover relative to the lower grill housing in order to maintain and control the heat production (ΔH) within the closed gas grill for cleaning the cooking grate member during a self-cleaning cycle. Further, one of the walls of the lower grill housing includes an exhaust fan being attached thereto for venting and dissipating the vaporized fumes to the outside air from the burning of the encrusted food residues on the cooking grate member during the self-cleaning cycle.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a front perspective view of the portable gas barbecue grill of the preferred embodiment of the present invention showing the major component parts within its grill housing;

FIG. 2 is a cross-sectional perspective view of the portable gas barbecue grill of the present invention taken along lines 2-2 of FIG. 1 in the direction of the arrows showing a grill cover, a lower grill housing, a cooking grill or grate member having heating members connected thereto, a grill stand and a propane gas container;

FIG. 3 is rear perspective view of the portable gas barbecue grill of the present invention showing an exhaust fan attached to a side wall of the lower grill housing;

FIG. 4 is a top perspective view of the portable gas barbecue grill of the present invention showing the cooking grate member, the plurality of heating members, and an electric self-cleaning unit having a plurality of heating elements thereto for detachably connecting to the plurality of heating members, respectively;

FIG. 5 is an is a sectional view of the portable gas barbecue grill of the present invention showing the heat (ΔH) circulation within a closed grill for the self-cleaning of the cooking grate using a fan while in operational use thereof; and

FIG. 6 is a schematic representation of the portable gas barbecue grill of the present invention showing the steps for a self-cleaning cycle.

### DETAILED DESCRIPTION OF THE PREFERRED EMBODIMENT

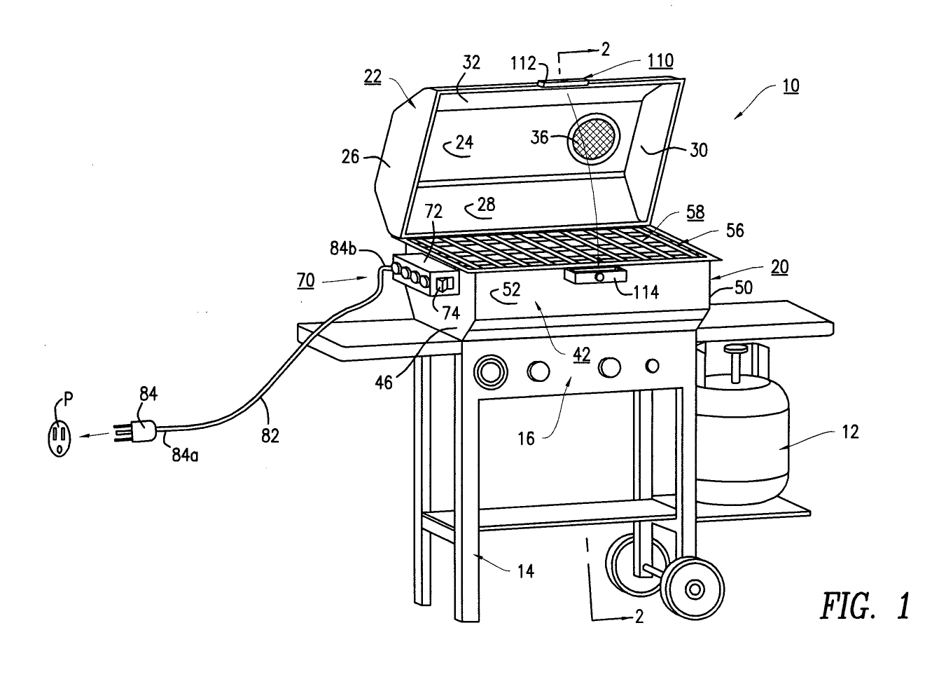

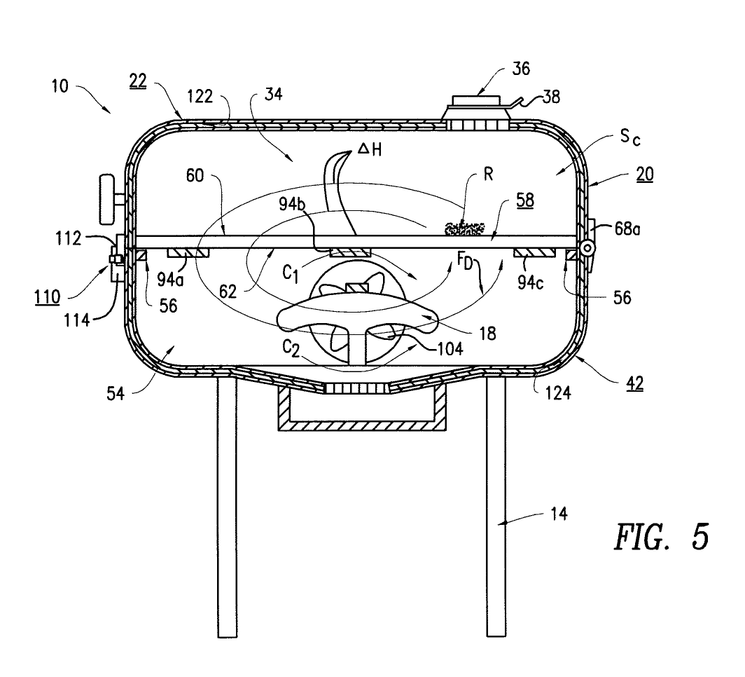

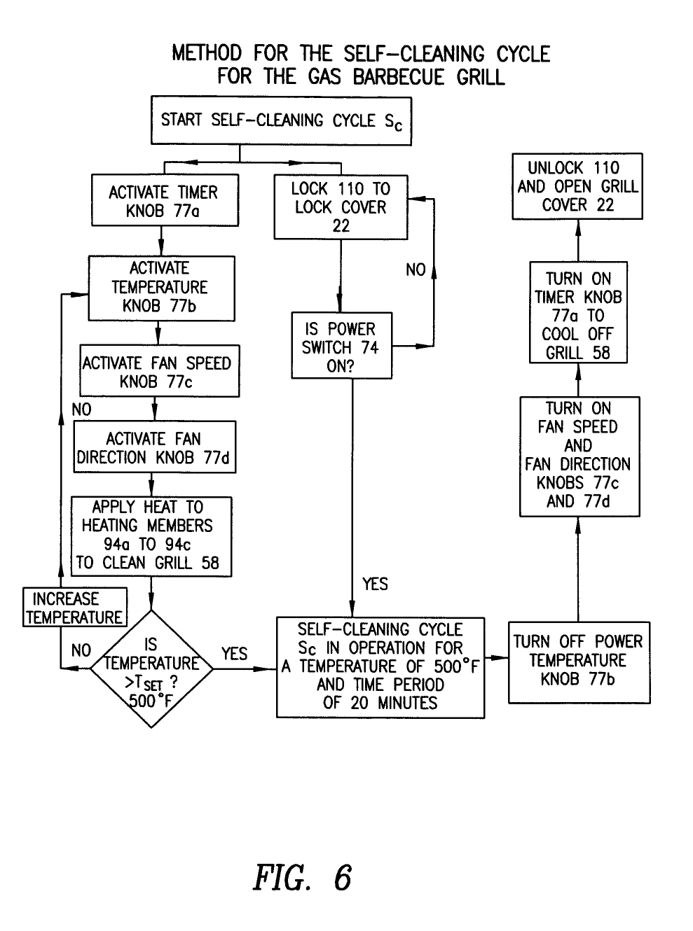

The portable outdoor gas barbecue grill 10 having an electric self-cleaning unit 70 and their component parts of the preferred embodiment of the present invention are represented in detail by FIGS. 1 through 6 of the patent drawings. The electric self-cleaning unit 70 is used to bum-off and/or vaporize the encrusted and burnt food residues from a cooking grate member 58 in order to sanitize the cooking grate member 58 during the operation of a self-cleaning cycle S_{C}, as shown in FIGS. 5 and 6 of the drawings.

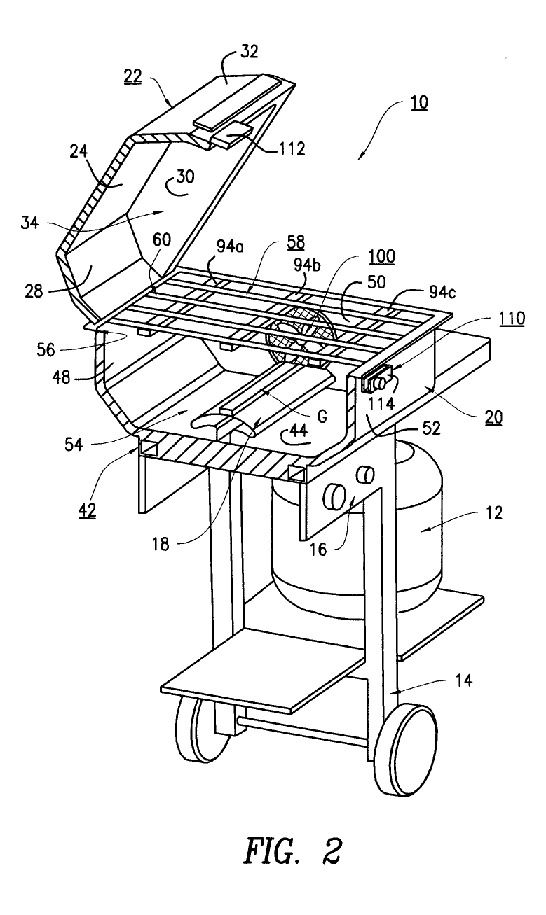

The portable outdoor gas barbecue grill 10 includes a propane gas container 12, a grill stand 14 having a control panel 16 for gas distribution and a grill housing 20. The grill housing 20, as shown in FIGS. 1 and 2, includes a grill cover 22 and a lower grill housing 32. The grill cover 22 includes a top wall 24 and integrally connected side walls 26, 28, 30 and 32 for forming an upper interior compartment 34. Top wall 24 includes a vent opening 36 having a vent shut-off lid 38 for regulating the amount of heat (ΔH) discharged from the closed grill housing 20 when in operational use.

The lower grill housing 42, as depicted in FIGS. 1 and 2, includes a bottom wall 44 and integrally connected side walls 46, 48, 50 and 52 for forming a lower interior compartment 54. The lower interior compartment 54 includes an upper mounting surface 56 for detachably receiving and holding in place a cooking grate member 58 having a top side 60 and an underside 62. One of the side walls 46 includes a first opening 64 for receiving an electric self-cleaning unit 70 therein. Another side wall 50 includes a second opening or an exhaust port 66 for mounting an exhaust fan 100 thereon. Bottom wall 44 is used for receiving a gas burner member 18 thereon to allow the burning of gas (G) from the propane gas container 12 used for cooking.

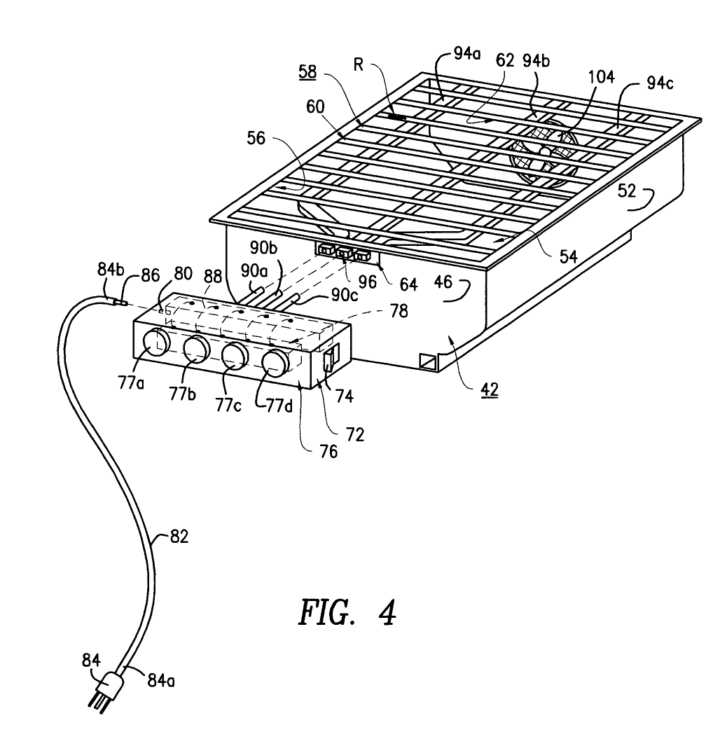

The electric self-cleaning unit 70, as shown in FIG. 4, includes a housing module 72 having an on-off toggle switch 74, a control panel 76 being electrically connected to an electronic chip board 78 for controlling temperature (T) in ° F., time (t) in minutes, fan control (F_{C}) in speed (rpm's) and fan direction (F_{D}) being clockwise C₁ (fan is blowing inwardly to the interior compartments 34 and 54, respectively) or counter-clockwise C₂ (fan is exhausting the fumes, air and heat from the interior compartments 34 and 54, respectively). Control panel 76 includes a plurality of control knobs 77a, 77b, 77c and 77d. Control knob 77a is used for activating a timer circuit for controlling the time (t) in minutes of the self-cleaning cycle S_{C}. Control knob 77b is used to initiate a high energy thermal cycle in ° F., where the temperature (T) may be set between 500° F. to 900° F. A temperature of at least 500° F. has to be reached in the self-cleaning cycle. Control knob 77c is used to control the fan speed in rpm's and control knob 77d is used to control fan direction (F_{D}) which is clockwise (C₁) during the heat (ΔH) production process or which is counter-clockwise (C₂) to exhaust fumes, hot air and heat (ΔH) from the grill housing 20 during the cooling process. The housing module 72 also includes a female connector member 80 for receiving a detachable electric cord 82. The detachable electric cord 82 has a first end 82a and a second end 82b. The first end 84a includes a standard 3-pole plug 84 for connecting to a power source (P) and the second end 82b includes a single male plug member 86 for manually connecting to an electrical conductor member 88 for supplying electric power in the form of voltage to the electric self-cleaning unit 70. The electric conductor member 88 includes a plurality of heating elements 90a, 90b and 90c for detachably connecting by connection means 12 to a plurality of heating members 94a, 94b and 94c being attached to the underside 62 of the cooking grate member 58. Each of the heating members 94a, 94b and 94c are attached to the underside 62 of the cooking grate member 58 by connectors or by welding in an equally spaced-apart manner. The cooking grate member 58 is heated to a sufficient temperature (T) to start the burning-off of food residues ( R ) on the grate member 58. Connection means 92, as shown in FIG. 4, includes insert openings 96 such that each of the heating elements 90a to 90c are received within insert passageway openings 96 of heating members 94a to 94c, respectively. Other connection means can be quick-release pins/brackets attached to each of the heating elements 90a to 90c which are detachably mounted to each of the heating members 94a to 94c, respectively.

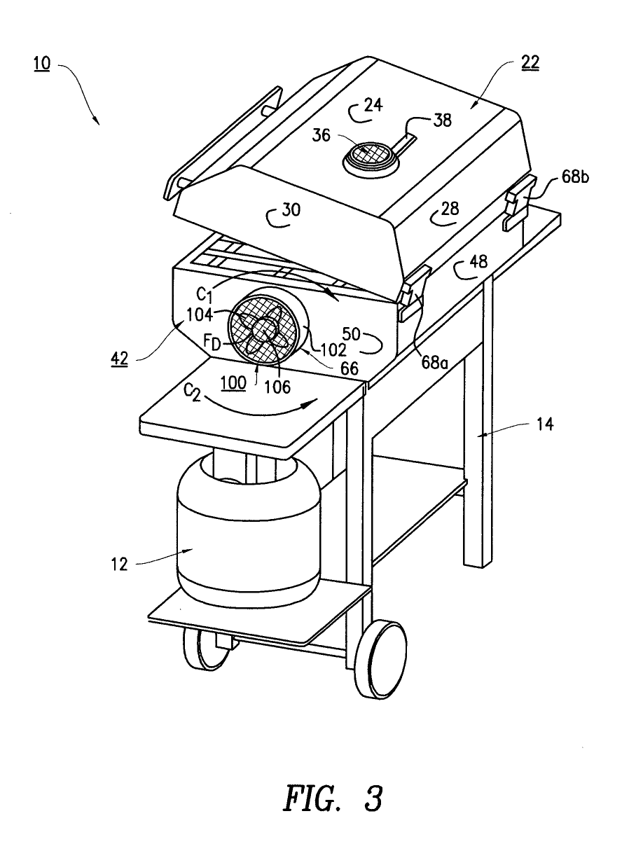

The exhaust fan 100 is externally mounted to second opening 66 of side wall 50 of the lower grill housing 42, as depicted in FIG. 3 of the drawings. Exhaust fan 100 includes a fan housing 102 having a fan member 104 and a reversible motor 106. Reversible motor 106 is electrically connected to the control panel 756 on the electric self-cleaning unit 70 for controlling motor 106 direction, as well as fan member 104 speed. The electrical reversible motor 106 allows the fan member 104 to exhaust the fumes, air and heat (ΔH) from the interior compartments 34 and 54, respectively, when moving in a counter-clockwise manner C₂ after the self-cleaning cycle S_{C} is completed. Conversely, the electrical reversible motor 106 allows the fan member 104 to blow air inwardly to the interior compartments 34 and 54, respectively, of grill housing 20 when moving in a clockwise manner C₁ during the heat (ΔH) production process and the self-cleaning cycle S_{C}. The electric reversible motor 106 is powered by the on-off toggle switch 74 on control panel 76.

The grill cover 22 is hingedly connected by hinges 68a and 68b to the lower grill housing 42 for opening and closing of the gas grill 10 during operational use. Further, gas grill 10 includes a grill lock 110 attached to front walls 32 and 52 of the grill cover 22 and lower grill housing 42, respectively, as shown in FIGS. 1 and 2 of the drawings. Grill lock 110 includes an upper lock section 112 on front wall 32 of grill cover 22 and a lower lock section 114 on front wall 52 of lower grill housing 42. Grill lock 110 is used for closing the grill cover 22 relative to the lower grill housing 42 in order to maintain and control the heat production (ΔH) from the electric self-cleaning unit 70 within the closed gas grill 10 for the cleaning of the cooking grate member 58 during the self-cleaning cycle S_{C}.

An alternate design for the grill cover 22 and lower grill housing 42 of grill housing 20, as shown in FIG. 5, includes a first insulation layer 122 in the walls 24 to 32 of the grill cover 22 and a second insulation layer 124 in the walls 44 to 52 of the lower grill housing. These insulation layers 122 and 124 are used to maintain the heat (ΔH) produced within the closed gas grill housing 20 during the self-cleaning cycle S_{C}.

In a typical self-cleaning cycle S_{C} the temperature of the heating members 94a to 94c on cooking grate member 58 reach a temperature of at least 500° F. for a time period of at least 20 minutes. The temperature (T) and time (t) can be varied so that at higher temperatures (T), ie. 600° F. to 900° F., a shorter time (t) period could be used such as 10 minutes. It is understood the self-cleaning cycle S_{C} includes continuous cleaning; catalytic cleaning and/or pyrolytic cleaning which uses different temperatures between 500° F. to 900° F. during cycle S_{C}.

### OPERATION OF THE PRESENT INVENTION

As shown in FIGS. 1 to 6, the portable outdoor gas barbecue grill 10 having an electric built-in self-cleaning unit 70 operates in the following manner: After the gas grill barbecue grill 10 has been used for cooking, the user initiates and starts up the self-cleaning cycle S_{C} by attaching and mounting the unit housing module 72 of the electric self-cleaning unit 70 to first opening 64 of side wall 46 on the lower grill housing 42. The user then detachably connects the plurality of heating elements 90a to 90c by connection means 92 to the plurality of heating members 94a to 94c, respectively. Next, the user detachably connects the electric cord 82 to housing module 72, such that the male plug member 86 is manually connected to the female connector member 80 thereby electrically connecting to the electrical conductor member 88. Plug 84 is electrically connected to the power source (P), so that power to housing module 72 is now in the ready mode to be activated.

The user now closes the grill cover 22 relative to the lower grill housing 42 and then locks the grill cover 22 to the lower grill housing 42 using grill lock 110. This locking procedure assures that the grill housing 20 will maintain and control the heat production (ΔH) from the electric self-cleaning unit 70 within the closed gas grill 10 for cleaning the cooking grate member 58 during the self-cleaning cycle S_{C}. The user then activates the on-off toggle switch 74 to the “ON” position, and then the user activates each of the control knobs 77a to 77d to a particular setting. For example, control knob 77a is set for 20 minutes, control knob 77b is set for 500° F., control knob 77c is set for a low to moderate rpm setting for the fan, and control knob 77d is set for a fan direction F_{D} such as a clockwise direction C₁ for blowing air inwardly into the interior compartments 34 and 54, respectively, of the grill housing 20 of closed gas grill 10, as shown in FIGS. 5 and 6 of the drawings.

The self-cleaning cycle S_{C} now proceeds, once the temperature of at least 500° F. is reached on the heating members 94a to 94c within the grill housing 20. The self-cleaning cycle S_{C} is now operational for a temperature of 500° F. and a time period of 20 minutes. The plurality of heating members 94a to 94c are burning off and/or vaporizing the burnt food residues and the food encrusted matter R left on the cooking grate member 58 after cooking.

After the self-cleaning cycle S_{C} has been completed, the temperature control knob 77b is turned off and the time control knob 77a is now set for 40 minutes for a time delay to cool off the cooking grate member 58. The fan control knob 77c is now set on a high rpm setting and the fan direction control knob 77d is now set for a counter-clockwise direction C₂ to exhaust all fumes, hot air and heat (ΔH) to the outside air from the interior compartments 34 and 54, respectively, of grill housing 20. After the grill housing 20 has been sufficiently cooled down for 40 minutes, the grill lock 110 is then opened and the grill cover 22 is then opened relative to the lower grill housing 42. The toggle switch 74 is then switched to an “OFF” position, and the user detachably removes the heating elements 90a to 90c from the heating members 94a to 94c. In the last step, the user dismantles housing module 72 from wall 46 of the lower grill housing 42, such that the outdoor gas barbecue grill 10 is now ready for re-use for cooking again.

### ADVANTAGES OF THE PRESENT INVENTION

Accordingly, an advantage of the present invention is that it provides for an outdoor gas barbecue grill having an electric self-cleaning unit connected to the underside of a cooking grill or grate member to produce a temperature of over 500° F. during a self-cleaning cycle to burn-off and/or vaporize the encrusted and burnt food residues from the cooking grate member.

Another advantage of the present invention is that it provides for a portable gas barbecue grill that includes a detachable electric self-cleaning heating unit for heating the cooking grate member at temperatures between 500° F. to 900° F. in order to burn off the encrusted and burnt food residues from the food-adhering cooking grate member.

Another advantage of the present invention is that it provides for a portable gas barbecue grill having an exhaust fan attached to one of the side walls of the lower grill housing for venting and dissipating the vaporized fumes to the outside air from the burning off and/or vaporization of the burnt food residues and food encrusted matter left on the cooking grate member after cooking.

Another advantage of the present invention is that it provides for a portable gas barbecue grill having a grill lock for closing the grill cover relative to the lower grill housing in order to maintain and control the heat production within the closed gas barbecue grill for cleaning the cooking grate member during the self-cleaning cycle.

Another advantage of the present invention is that it provides for a portable gas barbecue grill that includes insulation layers in the walls of the grill cover and the lower grill housing in order to maintain the heat produced within the closed gas grill.

Another advantage of the present invention is that it provides for an electric self-cleaning unit that is easy to assembly and to mount, and to maintain when in operational use by the operator.

Another advantage of the present invention is that it provides for an electric self-cleaning unit having no moving parts that is easy to use and is durable for repeated use by the operator.

A further advantage of the present invention is that it provides for a portable gas barbecue grill having an electric self-cleaning unit that can be mass-produced in an automated and economical manner and is readily affordable by the consumer.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. An outdoor gas barbecue grill having an electric self-cleaning heating unit, comprising:
a) a gas barbecue grill including a grill housing; said grill housing including a grill cover having walls for forming an upper interior compartment;
b) said grill housing including a lower grill housing having walls, a bottom surface and a mounting surface for forming a lower interior compartment; said bottom surface for receiving a gas burner thereon;
c) said mounting surface for detachably supporting a cooking grate member thereon; said cooking grate member having a topside and an underside;
d) said underside of said cooking grate member including a plurality of heating members made of metal;
e) one of said walls of said lower grill housing including an electric self-cleaning heating unit mounted thereon; said electric heating unit including an electrical conductor member connected to a plurality of heating elements for detachably connecting to said plurality of heating members on said cooking grate for heating of said heating members to at least 500° F. in a self-cleaning cycle to bum off and clean the encrusted and burnt food residues on said cooking grate member;
f) said grill cover being hingedly connected to said lower grill housing;
g) a grill lock being connected to said lower grill cover and to said lower grill housing; said grill lock for locking said grill cover relative to said lower grill housing in order to maintain and control the heat production (ΔH) within said closed gas grill for cleaning said cooking grate member during said self-cleaning cycle; and
h) said grill housing including an exhaust port being attached thereto for venting and dissipating the vaporized fumes to the outside air from the burning of the encrusted food residues on said cooking grate member during said self-cleaning cycle.

2. An outdoor gas barbecue grill in accordance with claim 1, wherein said plurality of heating members are positioned in a spaced-apart manner on the underside of said cooking grate member.

3. An outdoor gas barbecue grill in accordance with claim 1, wherein said plurality of heating members are three (3) bar-shaped or rod-shaped heating members.

4. An outdoor gas barbecue grill in accordance with claim 1, wherein said plurality of heating elements include connecting means for detachably connecting said heating elements to said plurality of heating members.

5. An outdoor gas barbecue grill in accordance with claim 1, wherein said self-cleaning cycle produces heat (ΔH) at a temperature of at least 500° F. and for a time period of at least 20 minutes.

6. An outdoor gas barbecue grill in accordance with claim 1, wherein said heating elements operate in said self-cleaning cycle to produce temperatures on said cooking grate member of between 500° F. to 900° F. in order to clean said cooking grate member.

7. An outdoor gas barbecue grill in accordance with claim 1, wherein said electric self-cleaning heating unit include means for controlling the temperature, the heating time, the fan operation, and the power.

8. An outdoor gas barbecue grill in accordance with claim 1, wherein said exhaust port includes an exhaust fan attached to one of said walls of said grill housing for exhausting, venting and dissipating the vaporized fumes to the outside air from the burning of the encrusted food residues on said cooking grate member during said self-cleaning cycle.

9. An outdoor gas barbecue grill in accordance with claim 8, wherein said exhaust fan has a circulating fan mode for circulating the heated air and fumes within said closed gas grill during said self-cleaning cycle.

10. An outdoor gas barbecue grill in accordance with claim 1, wherein said grill cover includes a vent opening having a vent lid for regulating the amount of heat to dissipate and for regulating the amount of outside air for the cooking process.

11. An outdoor gas barbecue grill in accordance with claim 1, further including a first insulation layer in the walls of said grill cover and a second insulation layer in the walls of said lower grill housing in order to maintain the heat (ΔH) produced within said closed gas grill during said self-cleaning cycle.

12. An outdoor gas barbecue grill in accordance with claim 1, wherein said electric self-cleaning heating unit further includes a detachable electric cord having a first end and a second end; said first end includes a standard 3-pole plug for connecting to a power source and said second end includes a male plug member for manually connecting to said electrical conductor member of said electric heating unit for supplying power thereto to produce the heat (ΔH) required.
